(19) United States
(12) Patent Application Publication
(10) Pub. No.: US 2023/0105297 A1
(43) Pub. Date: Apr. 6, 2023

(54) HANG ON BACK FILTERING UNIT FOR AQUARIUM TANK

(71) Applicant: ASKOLL HOLDING S.r.l. a socio unico, Dueville (VI) (IT)

(72) Inventor: Elio Marioni, Dueville (Vicenza) (IT)

(73) Assignee: ASKOLL HOLDING S.r.l. a socio unico, Dueville (VI) (IT)

(21) Appl. No.: 17/956,622

(22) Filed: Sep. 29, 2022

(30) Foreign Application Priority Data
Oct. 1, 2021 (IT) 102021000025226

(51) Int. Cl. A01K 63/04; B01D 35/153; B01D 29/56; B01D 39/14; C02F 1/00

(52) U.S. Cl. CPC A01K 63/045; B01D 35/153; B01D 29/56; B01D 39/14; C02F 1/001; B01D 2239/1291; C02F 2103/20

(57) ABSTRACT

A filtering unit (1) for aquariums of the hang on back type comprising: a housing (6); a suction pipe (2) provided with a lower inlet (3); and a pump (5) integral with said housing (6) and configured to determine a water circulation through a recirculation path extended inside the filtering unit (1) between said inlet (3) and said outlet mouth (4), wherein a non-return valve (10) is advantageously provided upstream of the pump (5) to maintain a water volume necessary for priming the pump (5) itself.

### CROSS-REFERENCE TO RELATED APPLICATIONS

The present application claims priority to Italian Patent Application No. 102021000025226, filed on Oct. 1, 2021, the entirety of which is incorporated herein by reference.

### FIELD OF APPLICATION

In its more general aspect, the present invention relates to a filtering unit for aquarium. Particularly the invention relates to a filtering unit arranged to be hung on the rear wall of the aquarium tank, according to a configuration called “hang on back”.

The invention finds useful application in the aquarium field as an accessory for aquariums, especially for home aquariums.

### PRIOR ART

As it is known to the skilled persons, the correct setup of an aquarium usually provides for the installation of a filtering unit, which provides a water recirculation and purification action, useful for the physiological well-being of the fish fauna contained in the tank.

The filtering units may be inside or outside the aquarium tanks. The internal filtering units have the drawback of occupying a portion of the aquarium volume and are less appreciated by aquarists due to the consequent visual impact. On the other hand, the external filtering units require enough space outside the structure and pose the risks of hydraulic leaks at the necessary connections with the aquarium tank.

To avoid the drawbacks of both categories, filtering units which, despite being external, hang on the back wall of the aquarium tank, are proposed on the market. These units, generally identified as hang on back filters, generally have an integral suction pipe and a water return mouth which opens directly above the tank, beyond the support bridge placed astride the rear wall. Therefore, the presence of the filter inside the water volume is avoided, with a limited external footprint and without resorting to extensive hydraulic connections.

In the hang on back filtering units, the pump is generally hung outside the structure, along with the housing of the filtering bodies. To allow priming the pump in the event of any restarts, it is provided that it works under the head, i.e. that the water level inside the aquarium is always higher than the height of the pump.

Over time, however, the water level in the aquarium tank may drop below the threshold identified above due to evaporation, without the owner of the aquarium noticing and refilling the container. This eventuality does not hinder the operation of the running pump: as long as the pump remains in operation, the suction pipe continues sucking and remains full of water. However, if the pump stops, the pipe empties, and the water level inside the filter drops below the volute of the pump. Therefore, the pump attempts a dry start and fails to create the vacuum necessary to refill the suction pipe and restart the recycling of water through the filtering unit.

The eventuality described above may occur, for instance, in the event of a power failure. When the electricity returns, the pump does not restart due to a lack of priming. In this case, who manages the aquarium must restore the correct functionality of the filter as soon as possible, to avoid repercussions on the well-being of the fish fauna housed in the tank.

However, it may happen that this person does not immediately realize what has happened, or that due to technical ignorance he/she does not identify the cause of the block in the lack of priming and does not know how to intervene effectively, with frustration of the user and possible consequences on the fish fauna.

The technical problem of the present invention is thus that of providing a hang on back filtering unit which solves the drawback identified with reference to the prior art, namely which prevents the pump disengagement and idle operation in the event of an unintentional interruption of the power supply.

The hang on back filters that have the pump hanging inside the tank, and therefore completely immersed in water, still do not solve the problem described above, since they always have to ensure that the water level in the aquarium is always higher than the height of the pump. In addition to a larger footprint in the tank, a higher degree of protection (IP68) than that required for non-submerged pumps is required by the regulations.

For both constructions, the return flow that occurs in the circumstances described above inevitably determines the pouring into the aquarium of dirty water, with further discomfort for the user.

### SUMMARY OF THE INVENTION

The above technical problem is solved by a filtering unit for aquariums comprising: a housing comprising at least one filter therein and provided with an upper outlet mouth; a suction pipe connected with a lower inlet; and a pump integral with said housing and configured to determine a water circulation through a recirculation path extended inside the filtering unit between said inlet and said outlet mouth, said recirculation path being intercepted by said at least one filter.

It is noted that the filter may be a mechanical filter, a biologic filter, a chemical filter, or even another kind of filter or a combination of the preceding ones.

The filtering unit is of the hang on back type, namely it is arranged to be hung on a wall of an aquarium tank with at least part of said housing placed outside the aquarium tank, said suction pipe drawing inside a water volume of the aquarium tank and said outlet mouth opening above said water volume, preferably by means of a slide or waterfall. Preferably, the filtering unit has the pump placed outside the aquarium tank.

Finally, according to the present invention a non-return valve is provided along said recirculation path upstream of said pump. The non-return valve allows the passage of water from the inlet to the pump but prevents the return of water in the opposite direction.

By preventing the return of water, the non-return valve prevents the suction pipe from emptying upon interruption of the pump operation, even if the water level in the aquarium tank is lower than the height of the pump itself. In fact, the valve closes the suction pipe preventing the water return that would normally occur due to the principle of communicating vessels. In this way, a water volume is always maintained in the portion downstream of the suction pipe, which keeps the volute of the pump covered and ensures the correct priming upon restart.

It is noted, in a per se known manner, that the suction pipe is preferably a U-curved pipe, which connects the water inlet—generally placed at a lower height—with the pump.

Preferably, the non-return valve comprises a seat and a shutter body, said shutter body being free to slide within an ascending segment of the recirculation path above said seat. When the water is sucked by the pump, its pressure lifts the shutter body and moves it away from the seat along the ascending segment. When the suction stops, the shutter body falls along the ascending segment until it blocks on the seat; therefore, the weight of the overlying water column maintains it in position in the seat, preventing the water flow in the direction opposite to the suction one.

In an embodiment thereof, the shutter body is a sphere that is free to move along the ascending segment. Naturally, the sphere has a diameter smaller than that of the ascending segment and greater than that of the seat. This embodiment proves to be advantageous since it facilitates the dragging of the body by the water sucked by the pump and ensures a perfect seal on the seat which is conveniently designed to be circular. However, other geometries of the shutter body are possible.

Still in an embodiment thereof, the shutter body is made with a specific weight lower than the one of water, namely lower than 1 g/cm³, for example of plastic material.

In an embodiment, the ascending segment is a portion of the suction pipe. In this case, the seat may advantageously be defined by a local narrowing of said suction pipe (whose section will preferably not be lower than that of the inlet of the pump volute in order to avoid pressure drops), for instance defined by an internal shoulder.

To facilitate the construction of the device, the ascending segment may be provided to be defined by an upper portion of the suction pipe, and the segment upstream thereof to be defined by a lower portion, the two portions being defined by distinct pieces joined together upon assembly. Preferably, a connection sleeve defining the seat of the non-return valve is thus provided between the two distinct portions.

Preferably, a sealing gasket may be inserted at the above narrowing, for instance an annular gasket; however, said component is not strictly necessary, since a perfect hydraulic seal does not seem necessary to achieve the purpose of the invention. In fact, it is noted that even a hydraulic seal ensuring a temporally limited stop of the return water into the tank fulfills the aforementioned purpose.

In an embodiment, the suction pipe, at an upper end of said ascending segment where the shutter body is free to slide, has a recess for housing said shutter body during operation of the filtering unit. By inserting into the recess, the shutter body frees the water passage section so as not to obstruct the flow, minimizing load losses.

Preferably, a guide shape or rib is present to direct the shutter body dragged by the water flow sucked into the aforementioned recess.

Preferably, the recess has a lower surface for supporting the shutter body, sloped toward the ascending segment to facilitate the return thereof toward the seat in case of stop of the sucked water flow. This measure avoids the recess to represent a minimum of local potential should the shutter body grip and not perform its function of blocking the fluid return.

Preferably, the recess is offset with respect to a longitudinal axis of the suction pipe.

Preferably, the recess is obtained below a top U-portion of the del suction pipe.

In the preferred embodiments of the invention, the non-return valve is housed in an inlet body which is connected upstream to the suction pipe.

Preferably the inlet body, at least at a portion housing the non-return valve, has a diameter larger than the diameter of the suction pipe. This is advantageous since it avoids oversizing the suction pipe in order to fit the components of the non-return valve.

Preferably, the non-return valve comprises a seat and a shutter body both housed within a cavity of the inlet body, said shutter body being vertically movable along an inlet body axis.

Preferably, the inlet body axis is offset from a longitudinal axis of the suction pipe. This is expedient as the shutter body will not interfere with the water flow when raised above the seat; further, the bulk of the inlet body develops towards the centre of the aquarium tank and does not impinge on the aquarium walls.

In preferred embodiments, the inlet body comprises a base element and a cover, a disk-shaped insert being held between the base element and the cover, the disk-shaped element comprising a shaped lip which defines the seat of the non-return valve. Such a layout ensures the required tightness of the valve while maintaining a simple and cost-effective structure of the device.

Preferably, the inlet body has radial ribs projecting inwardly within the cavity to guide the shutter body along the inlet body axis. This feature is expedient as it ensures a smooth and guided movement of the shutter body without resorting to large sliding surfaces, where there could be friction building up because of limestone and other debris accumulating over time.

Preferably, the shutter body comprises a lower convex head adapted to abut on the seat and an open upper end. The convex head, preferably hemispherical, is conveniently adapted to tightly abut against a circular seat. An open upper end, as opposed to a closed volume such as a sphere, facilitates the manufacturing of the shutter body, for instance by injection moulding.

In preferred embodiments, the shutter body is shaped as a cup, with a hemispherical bottom and a cylindrical upper body meant to contact external guiding features, or as a mushroom, with a hemispherical bottom topped by a central upper shaft adapted to engage with a central vertical guide pin. The guiding feature and the guide pin are both integral with a housing of the non-return valve.

As a preferred option, the filtering unit further comprises a pre-filter upstream the lower inlet, the pre-filter being a foam body.

The pre-filter is meant to prevent large debris that might interfere with the functioning of the non-return valve from entering the lower inlet. However, the pre-filter is not meant to exert a strong filtering action, which is demanded at the mechanical filtering stages within the body of the filtering unit. In particular, it is not desired that smaller dirt particles be retained by the filter, since this would result in an unwanted backflush effect when the action of the pump is discontinued.

In view of the above, said foam body has a density comprised between 5 and 20 PPI; wherein said pre-filter has a diameter comprised between 3 and 7 cm.

As a skilled person understands, both the density of the foam and the diameter of the pre-filter are parameters that increase with the filtration action.

In an ideal case, a density around 10 PPI and a diameter around 5 cm assure the light filtration action required to the pre-filter; however, similar results may be obtained by lowering one parameter while increasing the other one. As a rule of thumb, the value obtained by multiplying the density of the foam body expressed in PPI and the diameter of the pre-filter expressed in cm is therefore preferably kept between 25 and 75.

In a best embodiment, the pre-filter is a solid foam body—preferably cylindrical—with longitudinal cuts crossing along an axis of the pre-filter, the lower inlet being wedged within the longitudinal cuts in order to mount the pre-filter therearound.

The feature of the longitudinal cuts advantageously replaces the cylindrical central hole, which is provided in standard foam filters, as its manufacturing is much more cost-effective.

Further features and advantages of the present invention will become apparent from the following description of seven preferred embodiments given by way of non-limiting examples with reference to the enclosed drawings.

### BRIEF DESCRIPTION OF THE DRAWINGS

FIG. 1 shows a perspective view of a filtering unit according to a first embodiment of the present invention;

FIG. 2 shows a side view, sectioned along the suction pipe, of the filtering unit of FIG. 1 in an operating configuration, with water flow sucked according to the direction identified by the arrow S;

FIG. 3 shows a side view, sectioned along the suction pipe, of the filtering unit of FIG. 1 in an off state of the pump, wherein the non-return valve prevents the flow return according to the direction identified by the arrow B;

FIG. 4 shows an exploded perspective view of the suction pipe of the filtering unit of FIG. 1;

FIG. 5 shows a perspective view of a filtering unit according to a second embodiment of the present invention;

FIG. 6 shows a side view, sectioned along the suction pipe, of the filtering unit of FIG. 5 in an operating configuration, with water flow sucked according to the direction identified by the arrow S;

FIG. 7 shows a side view, sectioned along the suction pipe, of the filtering unit of FIG. 5 in an off state of the pump, wherein the non-return valve prevents the flow return according to the direction identified by the arrow B;

FIG. 8 shows an enlarged detail of the inlet body of filtering unit shown in the side view of FIG. 6;

FIG. 9 shows an exploded perspective view of the inlet body of FIG. 8;

FIG. 10 shows a perspective view of a filtering unit according to a third embodiment of the present invention;

FIG. 11 shows a side view, sectioned along the suction pipe, of the filtering unit of FIG. 10 in an operating configuration, with water flow sucked according to the direction identified by the arrow S;

FIG. 12 shows a side view, sectioned along the suction pipe, of the filtering unit of FIG. 5 in an off state of the pump, wherein the non-return valve prevents the flow return according to the direction identified by the arrow B;

FIG. 13 shows an enlarged detail of the inlet body of filtering unit shown in the side view of FIG. 11;

FIG. 14 shows an exploded perspective view of the inlet body of FIG. 13;

FIG. 15 shows a sectioned side view of an inlet body of a filtering unit according to a fourth embodiment of the present invention;

FIG. 16 shows an exploded perspective view of the inlet body of FIG. 15;

FIG. 17 shows a sectioned side view of an inlet body of a filtering unit according to a fifth embodiment of the present invention;

FIG. 18 shows an exploded perspective view of the inlet body of FIG. 17;

FIG. 19 shows a sectioned side view of an inlet body of a filtering unit according to a sixth embodiment of the present invention;

FIG. 20 shows an exploded perspective view of the inlet body of FIG. 19;

FIG. 21 shows a sectioned side view of an inlet body of a filtering unit according to a seventh embodiment of the present invention;

FIG. 22 shows an exploded perspective view of the inlet body of FIG. 21.

### DETAILED DESCRIPTION

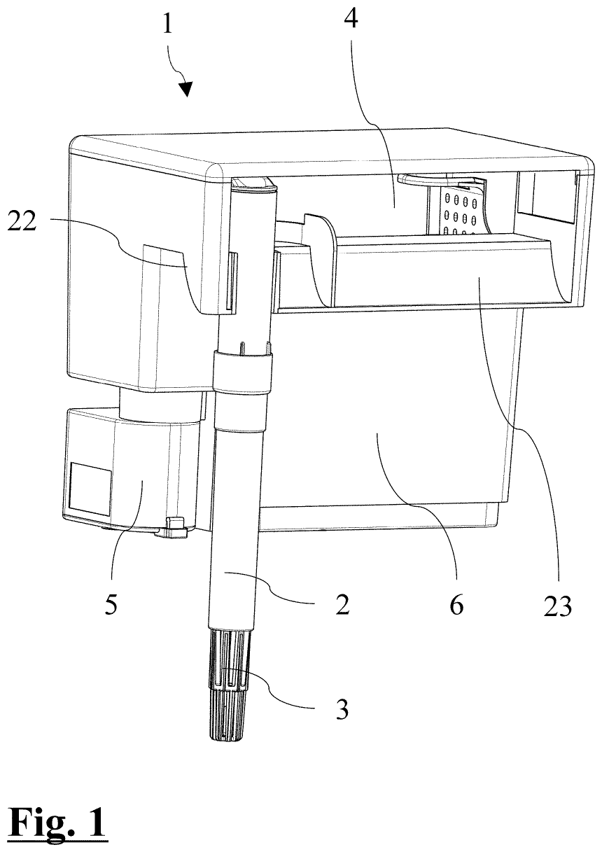

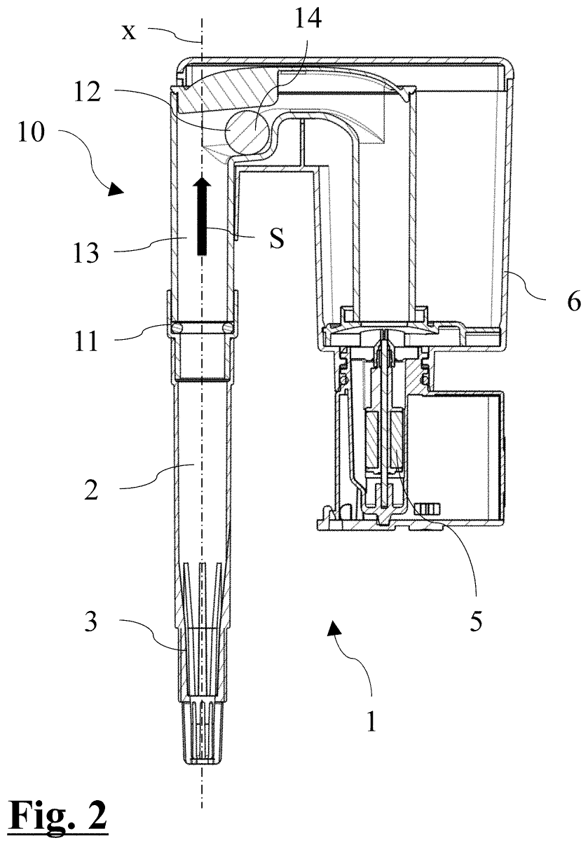

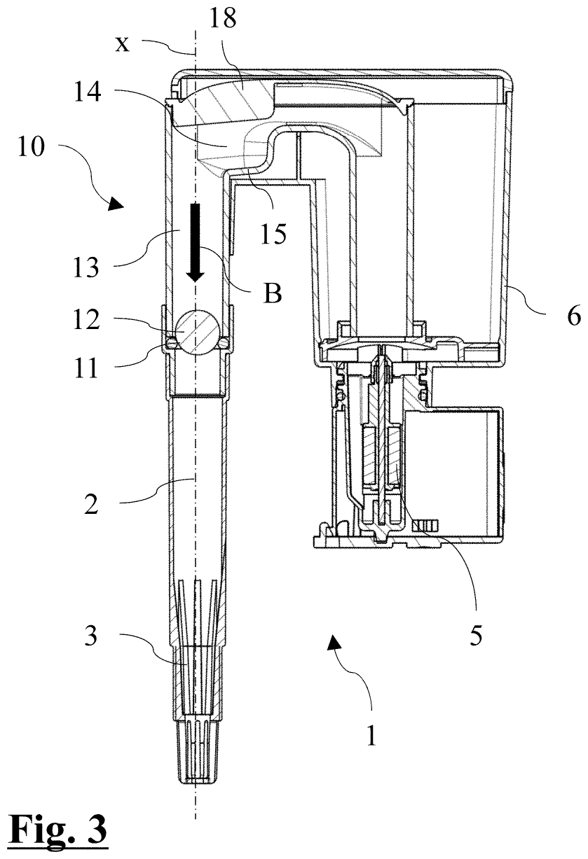

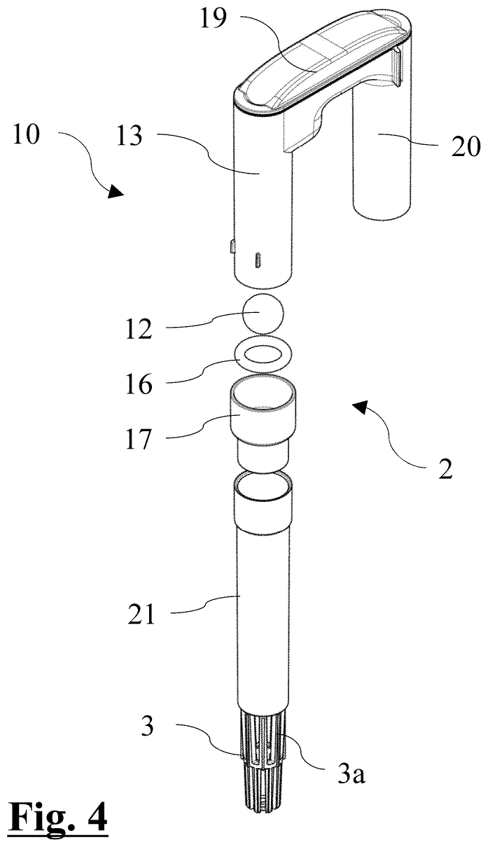

With reference to the enclosed FIGS. 1-3, reference number 1 generically identifies a first embodiment of a filtering unit according to the present invention.

In particular, a filtering unit for domestic aquariums of the so-called hang on back type is described, namely, designed to be hung astride above the rear wall of an aquarium tank (not illustrated).

The filtering unit 1 is represented in the figures according to a normal operating configuration; further in the present description, the relative and absolute positions and orientations of the various elements that make up the unit, defined by terms such as upper and lower, above and below, horizontal and vertical or other equivalent terms, should always be interpreted with reference to said configuration.

The filtering unit 1 comprises a box-shaped housing 6, inside which the filtering operations of a liquid flow drawn from the aquarium tank and reintroduced thereinto after filtering are carried out.

Externally the housing 6 has the shape of a parallelepiped, whose lower portion has a receding side part to make room for a pump 5, preferably represented by a synchronous electric pump. In a per se known manner, the housing 6 is provided with a projecting portion for connection 22 that allows it to be hung on the back wall of the aquarium tank.

Starting from the side of the projecting portion for connection 22 corresponding to the side with receding part of the housing 6, an outer portion of a suction pipe 2 extends vertically downwards. The lower end of said suction pipe 2, arranged for immersing into the water of the aquarium tank, has a plurality of longitudinal slots 3a which define a water inlet 3 for the filtering unit 1.

Along the extension of the projecting portion for connection 22 not affected by the presence of the suction pipe 2, a drop spillway defining an outlet mouth 4 of the filtering unit 1 opens. Below said outlet mouth, on the projecting portion for connection 22 a return chute 23 is defined, intended to accompany the fall of water now filtered into the aquarium tank.

Between the inlet 3 and the outlet mouth 4 at least one recirculation path develops, and the aforementioned pump 5 is intended to favour the water circulation along said path. The recirculation path passes through one or more filters contained in the housing 6; a by-pass path, also exiting at the same outlet mouth 4, is generally provided to maintain the water recirculation even in case of filter obstruction.

For the purposes of the present invention, the path portion to be described is the one upstream of the pump 5, which is defined by a suction pipe 2. Said suction pipe 2 is U-shaped and is made of an ascending portion, which develops from the inlet 3 up to a top capable of climbing over the back wall of the aquarium tank, and of a descending portion 20, which reaches the pump volute.

Structurally, the suction pipe 2 is made of a U-segment 19 on which a straight segment 21 engages below, which defines the inlet 3 at the lower end thereof. The U-segment 19 and the straight segment 21 join together by means of a connection sleeve 17 which inserts externally to the first one and internally to the second one.

Above the connection sleeve 17, in the ascending segment 13, a non-return valve 10 is defined.

The non-return valve is made of a shutter body 12, which has the shape of a sphere of plastic material with a specific weight lower than the one of water, which in the rest configuration is housed in a seat 11, defined by the narrowing of the connection sleeve 17 where a toroidal sealing gasket 16 is housed.

When the pump 5 is in action, the water flow drags the sphere 12 upwards along the ascending segment 13, unlocking the seat 11 and freeing the passage toward the pump 5 itself.

At the top of the ascending segment 13, which develops along a longitudinal axis x, a side recess 14 is provided, in which the sphere 12 is guided by a top rib 18, made inside the U-segment 19 of the suction pipe 2. The recess 14, which has a lower support surface 15 sloped towards the ascending segment 13, is obtained below with respect to the bend of the U-segment 19, and thus is offset from a main water passage path.

When the pump 5 is in operation, the sphere 12 is kept in the recess 14 by the kinetic energy of the water flowing in the duct and does not hinder the flow thereof. When the action of the pump 5 stops, the sphere 12 dragged by the return water slides along the lower sloped surface 15; then, it falls along the ascending segment 13 repositioning itself in the seat 11 in the locked position. Thus the return of water towards the inlet opening 3 is prevented, and a volume is maintained in the descending portion 20 of the U-pipe to allow priming the pump 5 at the following start.

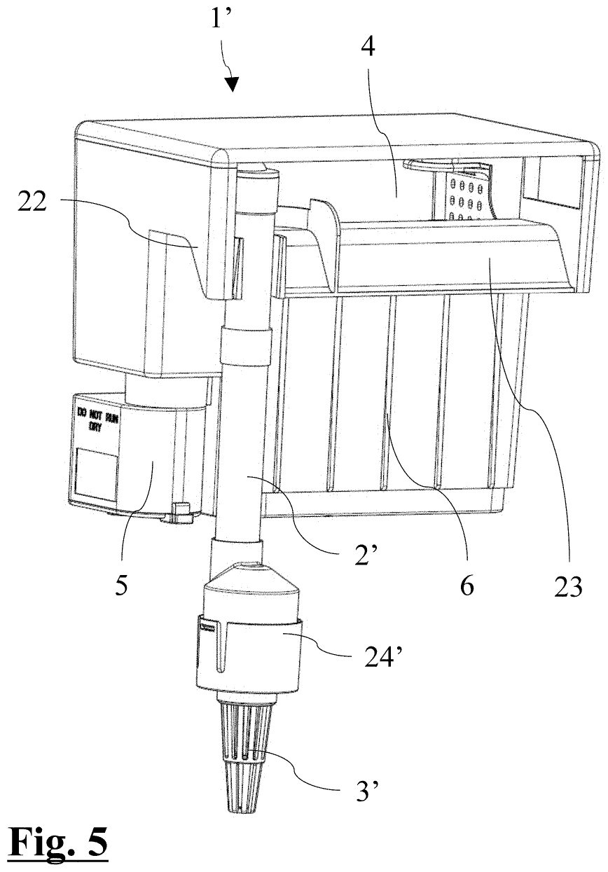

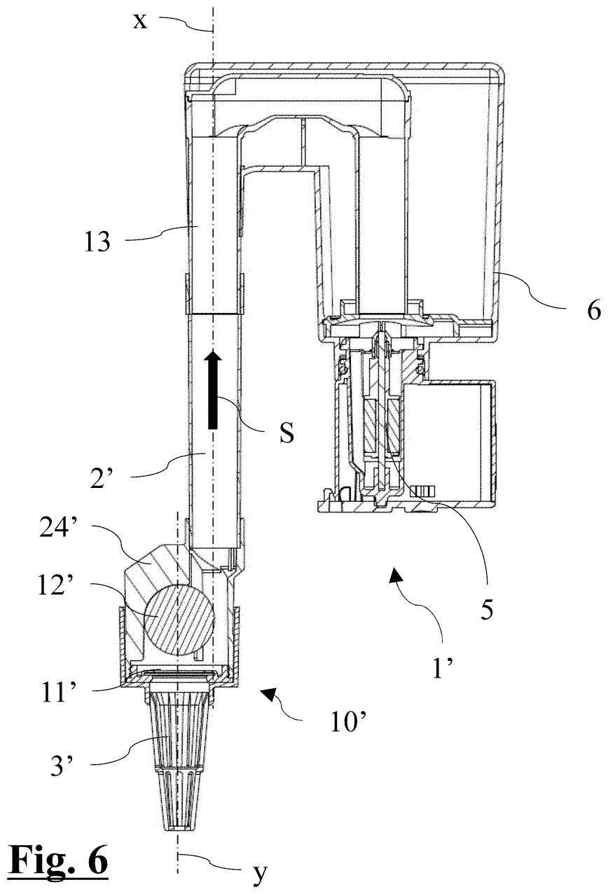

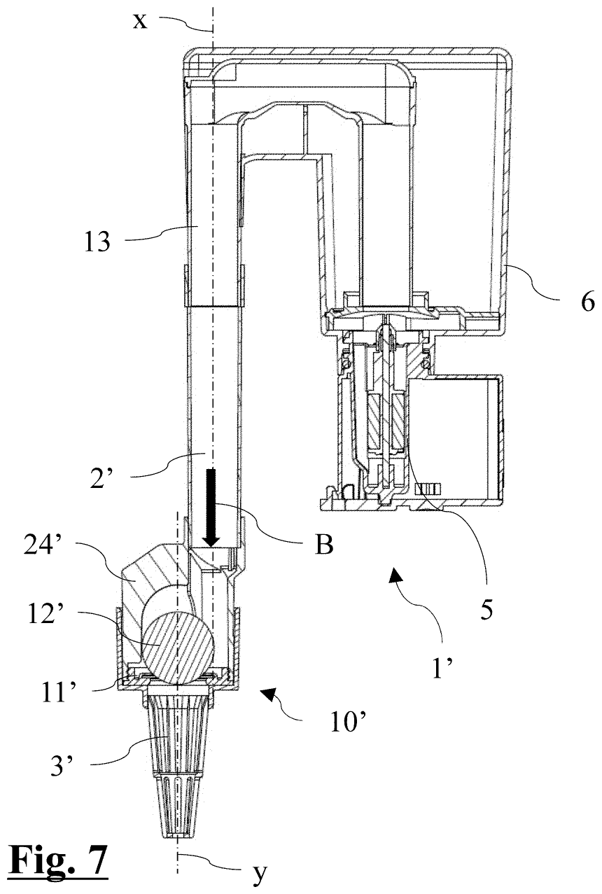

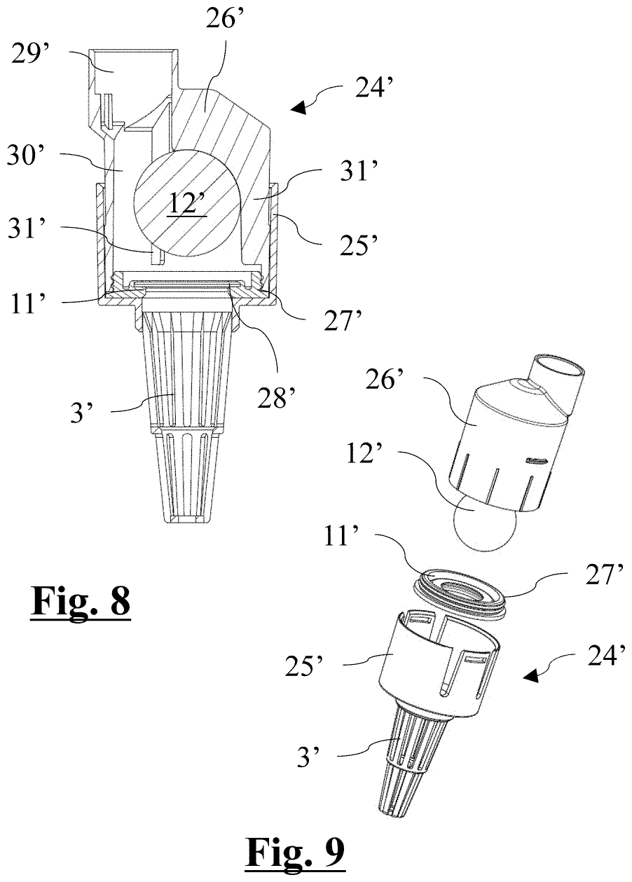

With reference to the enclosed FIGS. 5-7, reference number 1′ generically identifies a second embodiment of a filtering unit according to the present invention.

The filtering unit 1′ according to the second embodiment shares most of the components and features of the previous embodiment. Such components and features are therefore indicated in the figures by reference numerals previously used, and they are not described anew in the following paragraphs.

The filtering unit 1′ according to the second embodiment differs from the previous embodiment in that the suction pipe 2′ has an inlet body 24′ connected upstream, such an inlet body 24′ housing the non-return valve 10′.

The inlet body 24′ has an inlet body axis y which is slightly offset from the longitudinal axis x of the suction pipe, and it has a larger diameter so that the dimensions of the seat 11′ and shutter body 12′ are not constrained by the dimensions of the pipe 2′ above.

Preferably, the inlet body 24′ comprises a base element 25′ and a cover 26′. The bottom of the base element 25′ features a conical inlet 3′, having longitudinal slots for the access of water from the aquarium tank. Above, the base element 25′ features a cylindrical casing in which the cover 26′ is snap-fitted. The two elements may be disassembled for maintenance purpose. The cover 26′ has a dome-shaped top with a lateral aperture 29′ connecting with the lower end of the subsequent straight portion of the suction pipe 2′.

At the bottom of the cylindrical casing, above the conical inlet 3′, a disk-shaped insert 27′ is arranged that defines the seat 11′ of the non-return valve 10′. The disk-shaped insert 27′, which is preferably made of rubber, more preferably silicon rubber, features an inner hole contoured by a shaped lip 28′ onto which the shutter body 12′ accommodates.

In the actual embodiment, the shutter body 12′ is made as a sphere, just like in the first embodiment.

Within the inlet body 24′, an inner cavity 30′ is provided within which the water flows and the shutter body 12′ moves. The cover 26′ has inner radial ribs 31′ which guide the motion of the shutter body 12′ within the inner cavity along the inlet axis y′. In the depicted embodiment, the radial ribs 31′ are three in number, equally spaced along the cylindrical inner body of the cover 26′.

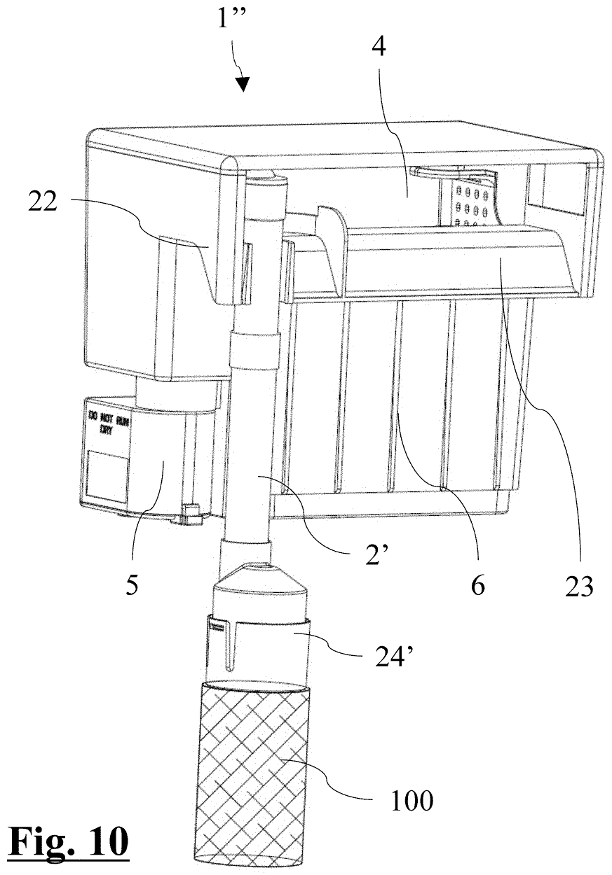

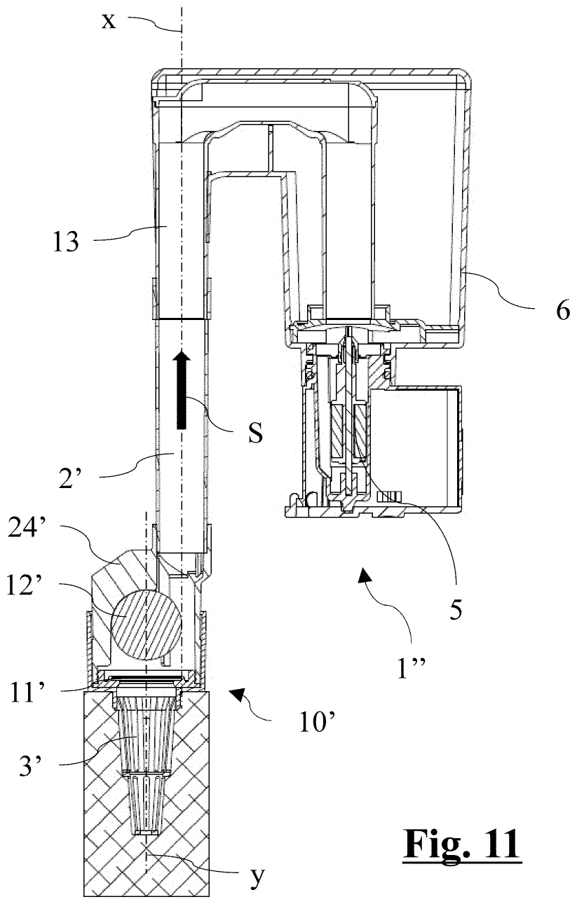

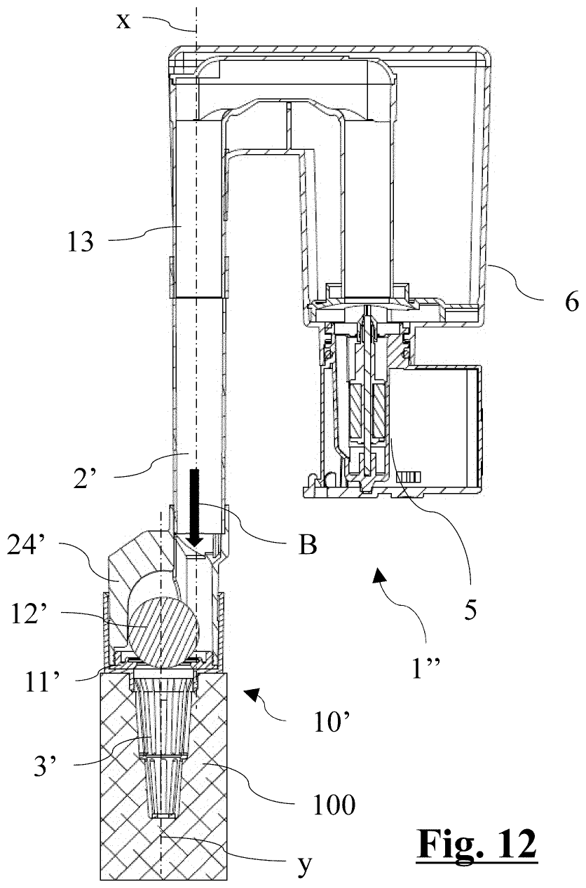

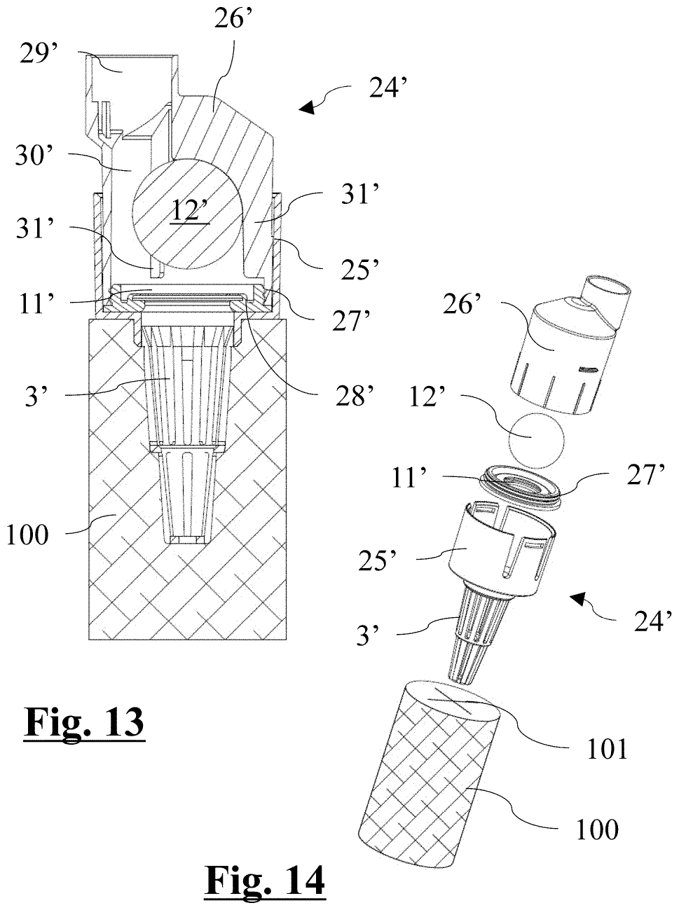

With reference to the enclosed FIGS. 10-12, reference number 1″ generically identifies a third embodiment of a filtering unit according to the present invention.

The third embodiment corresponds to the second embodiment apart from that a pre-filter 100 is provided around the conical inlet 3′.

The pre-filter 100 is a cylindrical foam filter with a density of 10 PPI (pores per inch) and a total diameter of 5 cm; however, as discussed in the summary of invention, these are indicative values which can be modified according to design needs.

The pre-filter 100 is made of a solid cylinder of foam provided with longitudinal cuts 101. Preferably, the longitudinal cuts 101 are two orthogonal cuts crossing on the axis of the pre-filter. The pre-filter 100 is mounted by wedging the conical inlet 3′ within the longitudinal cuts 101.

The pre-filter 100 has the sole purpose of preventing the access of larger debris that could possibly interfere with the operation of the non-return valve 10′.

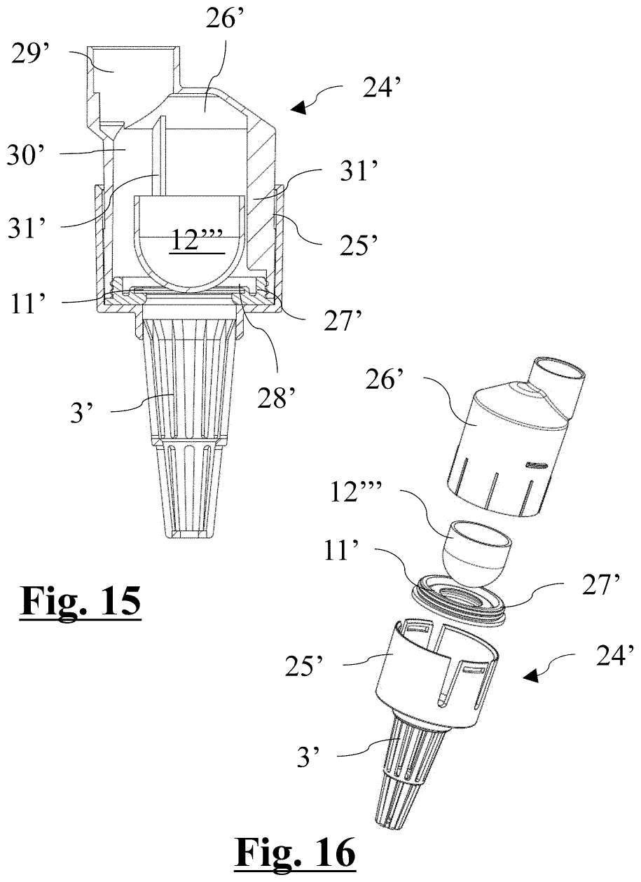

FIGS. 15 and 16 relate to a fourth embodiment of a filtering unit according to the present invention.

The fourth embodiment substantially corresponds to the previously discussed second embodiment, except for the fact that the shutter body 12″′ is a cup-shaped body instead of a sphere. In particular, the shutter body 12″′ has a hemispherical bottom portion and an upper cylindrical wall, which is vertically guided by the radial ribs 31′.

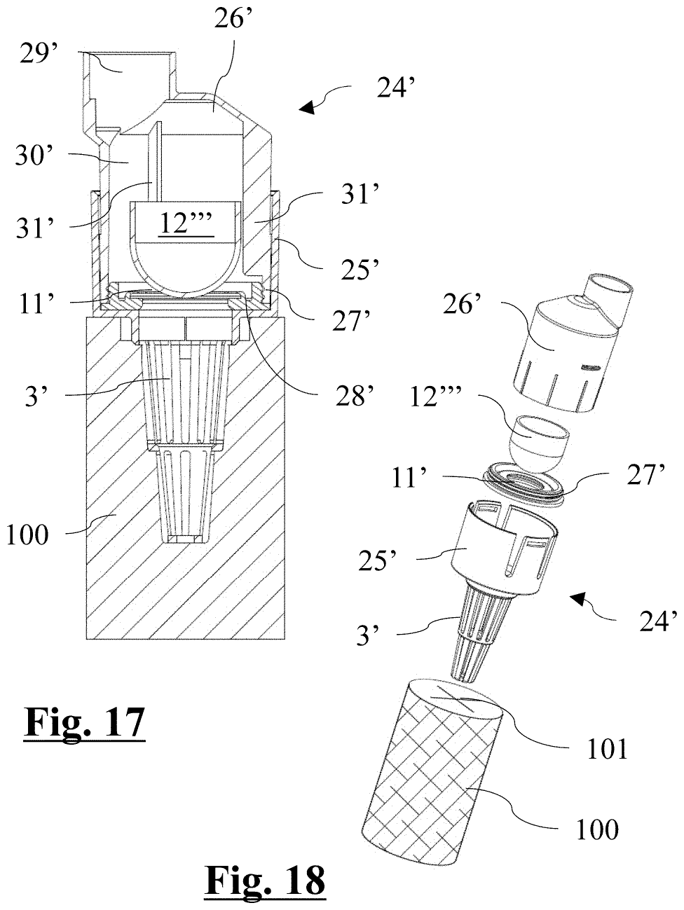

FIGS. 17 and 18 relate to a fifth embodiment of a filtering unit according to the present invention.

The fifth embodiment substantially corresponds to the previously discussed fourth embodiment but features a pre-filter 100 according to the third embodiment.

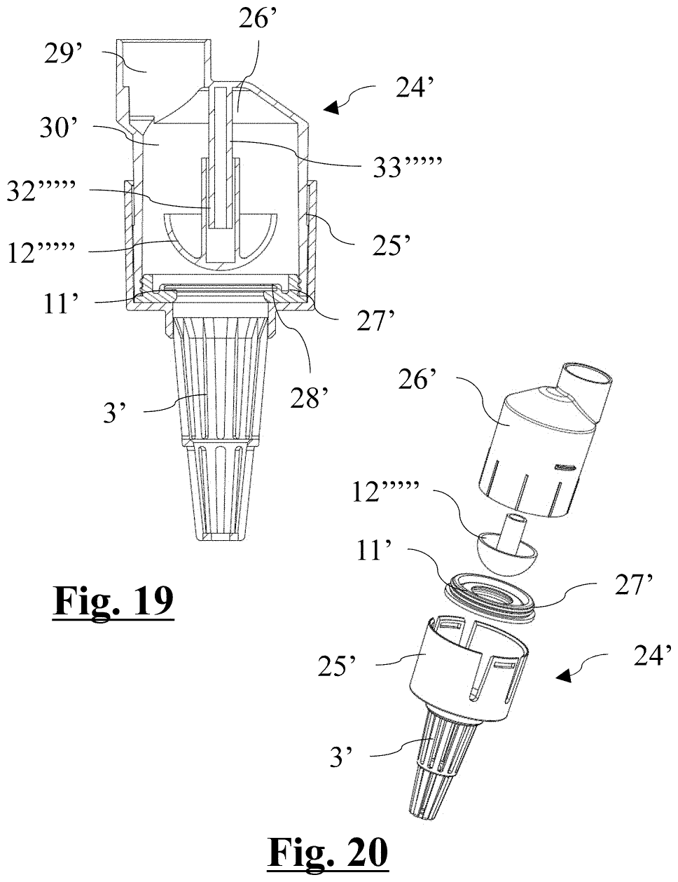

FIGS. 19 and 20 relate to a sixth embodiment of a filtering unit according to the present invention.

The sixth embodiment substantially corresponds to the previously discussed fourth embodiment, except for the fact that the shutter body 12″″ is mushroom-shaped. In particular, the shutter body 12″″ has a hemispherical bottom portion and an inner shaft 32″″ which is slidingly engaged over a vertical guide pin 33″″ integral with the ceiling of the cover 26′.

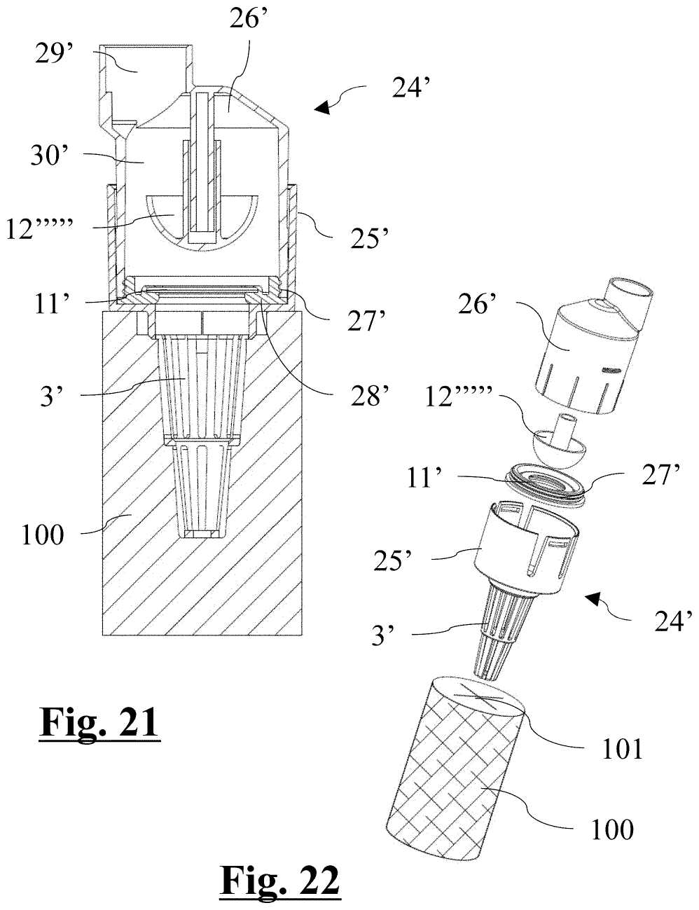

FIGS. 21 and 22 relate to a seventh embodiment of a filtering unit according to the present invention.

The seventh embodiment substantially corresponds to the previously discussed sixth embodiment but features a pre-filter 100 according to the third embodiment.

The above-described invention solves the technical problem previously identified. Moreover, it has the advantage of avoiding the return of non-filtered water into the tank in the event of a power failure.

Obviously, a skilled person can make several changes and variants to the above-described filtering unit, in order to meet contingent and specific needs, all of them by the way contained in the scope of protection of the invention as defined by the following claims.

1. A filtering unit for aquariums comprising: a housing comprising at least one filter therein and provided with an upper outlet mouth; a suction pipe connected with a lower inlet; and a pump integral with said housing and configured to determine a water circulation through a recirculation path extended inside the filtering unit between said inlet and said outlet mouth, said recirculation path being intercepted by said at least one filter; wherein said filtering unit is of the hang on back type, that is it is arranged to be hung on the wall of an aquarium tank with at least part of said housing placed outside the aquarium tank, said suction pipe drawing inside a water volume of the aquarium tank and said outlet mouth opening above said water volume; the filtering unit further comprising a non-return valve provided along said recirculation path upstream of said pump, said non-return valve allowing the passage of water from the inlet to the pump and preventing the return of water in the opposite direction.

2. The filtering unit according to claim 1, wherein said non-return valve comprises a seat and a shutter body, said shutter body being free to move within an ascending segment of the recirculation path above said seat.

3. The filtering unit according to claim 2, wherein said ascending segment is a portion of the suction pipe.

4. The filtering unit according to claim 3, wherein said seat is defined by a local narrowing of the suction pipe.

5. The filtering unit according to of claim 3, wherein the suction pipe, at an upper end of said ascending segment in which the shutter body is free to slide, has a recess for housing the shutter body during operation of the filtering unit.

6. The filtering unit according to claim 2, wherein said shutter body is a sphere.

7. The filtering unit according to claim 2, wherein said shutter body has a specific weight lower than the one of water.

8. The filtering unit according to claim 1, wherein the non-return valve is housed in an inlet body which is connected upstream to the suction pipe.

9. The filtering unit according to claim 8, wherein the inlet body, at least at a portion housing the non-return valve, has a diameter larger than the diameter of the suction pipe.

10. The filtering unit according to claim 8, wherein the non-return valve comprises a seat and a shutter body both housed within a cavity of the inlet body, said shutter body being vertically movable along an inlet body axis.

11. The filtering unit according to claim 10, wherein the inlet body axis is offset from a longitudinal axis of the suction pipe.

12. The filtering unit according to claim 10, wherein the inlet body comprises a base element and a cover, a disk-shaped insert being held between the base element and the cover, the disk-shaped element comprising a shaped lip which defines the seat of the non-return valve.

13. The filtering unit according to claim 8, wherein the inlet body has radial ribs projecting inwardly within the cavity to guide the shutter body along the inlet body axis.

14. The filtering unit according to claim 2, wherein the shutter body comprises a lower convex head adapted to abut on the seat and an open upper end.

15. The filtering unit according to claim 14, wherein said shutter body comprises an upper shaft opposed to the convex head, the upper shaft being adapted to engage with a vertical guide pin integral with a housing of the non-return valve.

16. The filtering unit according to claim 1, further comprising a pre-filter upstream the lower inlet, the pre-filter being a foam body.

17. The filtering unit according to claim 16, wherein said foam body has a density comprised between 5 and 20 PPI.

18. The filtering unit according to claim 16, wherein said pre-filter has a diameter comprised between 3 and 7 cm.

19. The filtering unit according to claim 16, wherein the value obtained by multiplying the density of the foam body expressed in PPI and the diameter of the pre-filter expressed in cm is between 25 and 75.

20. The filtering unit according to claim 16, wherein said pre-filter is a solid foam body with longitudinal cuts crossing along an axis of the pre-filter, the lower inlet being wedged within the longitudinal cuts in order to mount the pre-filter therearound.
